(19) United States
(12) Patent Application Publication
(10) Pub. No.: US 2004/0143845 A1
(43) Pub. Date: Jul. 22, 2004

(54) Remote control video recording and playing system and its method

(76) Inventors: Chi-Tai Lin, Taipei (TW); Chang-Tai Yu, Yi-Lan City (TW); Yi-Liang Ting, Taipei City (TW); Chao-Wei Sung, Taipei City (TW)

Correspondence Address: SUPREME PATENT SERVICES, POST OFFICE BOX 2339, SARATOGA, CA, 95070, US

(21) Appl. No.: 10/346,953

(22) Filed: Jan. 17, 2003

(51) Int. Cl. H04N 7/16; H04N 5/445; G06F 13/00; H04N 7/173

(52) U.S. Cl. 725/58; 725/88; 725/102; 725/8; 725/135

(57) ABSTRACT

The present invention provides a remote control video recording and playing system, and its method, comprising: at least a video program broadcasting system, a video server, and a client computer. A video program broadcasting system includes a channel sending video programs through the broadcasting network to the computers at the client's end. A video server stores a plurality of digital video programs, each corresponding to a broadcasted video program. The said video server is able to receive the user instructions, and to send the stored digital videos to the computer at the client end, both through the internet. A client computer is used for selecting channels, and sending instructions to the video server. The said client computer is able to receive the video programs broadcasted through the network, and record a plurality of digital video programs in the video server, each requested with a separate instruction, sent by the said video server through the internet simultaneously.

### FIELD OF THE INVENTION

The present invention is related to a video recording system and its method, and more particularly to a remote control video recording and playing system and its method.

### BACKGROUND OF THE INVENTION

Because of the limited functionality of the video playing system currently used by the program suppliers or broadcasting companies, such as TV station and cable operators, the viewers often encounter unpleasant viewing experiences causing frustrations, for example, tuning in the middle of a program, and unable to view it from the beginning. Other limitations include being unable to select a particular episode from the series, or unable to view on channel, while recording on multiple channels when using VCR, PVR or DVR.

The present invention provides the solutions for aforementioned viewing limitation, and make the viewing more convenient and enjoyable.

### SUMMARY OF THE INVENTION

The present invention is to provide the viewers the capability to record multiple channels simultaneously, while watching another programs on another channel. In addition, the present invention aims to provide the viewers more services and functions regarding the programs watched.

To achieve the goals set forth, the present invention provides a remote control video recording and playing system, comprising: at least a video program broadcasting system, at least a video server, and at least a client computer. A video program broadcasting system includes a channel sending video programs through the broadcasting network to the computers at the client's end. A video server stores a plurality of digital video programs, each corresponding to a broadcasted video program. The said video server is able to receive the user instructions, and to send the stored digital videos to the computer at the client end, both through the internet. A client computer is used for selecting channels, and sending instructions to the video server. The said client computer is able to receive the video programs broadcasted through the cable network, and record a plurality of digital video programs in the video server, each requested with a separate instruction, sent by the said video server through the internet simultaneously.

Further more, the present invention provides a remote control video recording and playing method, comprising: (a) providing at least a video program broadcasting system, wherein a channel sending video programs through the broadcasting network to the computers at the client's end; (b) providing a video server, wherein a plurality of digital video programs, each corresponding to a broadcasted video program, being stored; (c) said video server being able to receive a plurality of user instructions sent from client computers, wherein at least one of said instructions being recording instruction; (d) said video server sending the corresponding digital video programs, specified in step (c), to the computer at the client end, through the internet; (e) a client computer being used for selecting channels, and sending instructions to the video server; wherein said client computer being able to simultaneously receive the selected video programs broadcasted through the network, and record a plurality of digital video programs in the video server, each requested with a separate instruction, sent by the said video server through the internet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the system diagram of the present invention.

FIG. 2 shows the diagram of the video server.

FIG. 3 shows the diagram of the client computer.

FIG. 4 shows the data structure of user instructions.

FIG. 5 shows the diagram of executing record instruction.

FIG. 6 shows the diagram of executing instant replay instruction.

FIG. 7 shows the diagram of executing rating calculation instruction.

FIG. 8 shows the diagram of executing preview instruction.

FIG. 9 shows the diagram of executing poll instruction.

FIG. 10 shows the diagram of executing alternative view instruction.

FIG. 11 shows the diagram of executing episode selection instruction.

FIG. 12 shows the diagram of executing pause instruction.

FIG. 13 shows the diagram of executing channel auto-sync instruction.

FIG. 14 shows the diagram of executing multi-channel view instruction.

FIG. 15 shows the diagram of executing message delivery service instruction.

FIG. 16 shows the flowchart of the present invention.

### DETAILED DESCRIPTION OF THE INVENTION

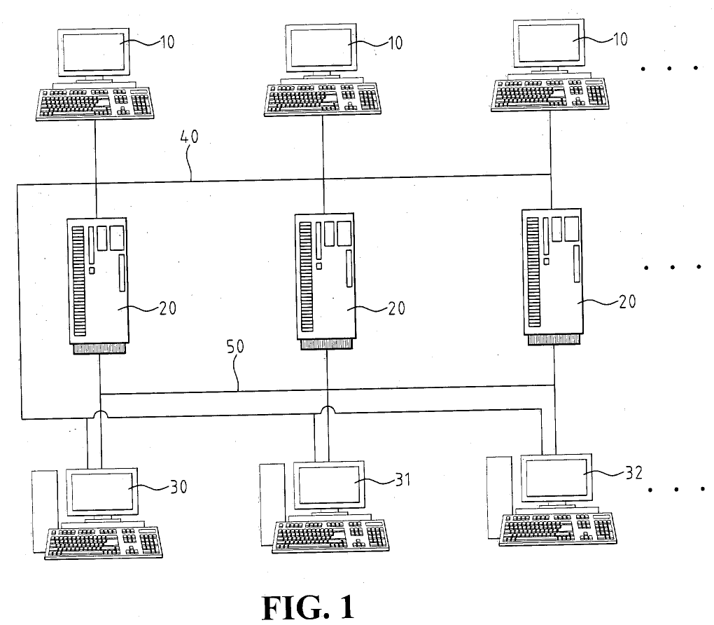

FIG. 1 shows the system structure of the present invention, comprising: at least a video program broadcasting system 10, at least a video server 20, and a plurality of client computers 30, 31, 32. The video program broadcasting system 10 connects the client computers 30, 31, 32, through broadcasting network 40, and the video server 20 connects the client computers 30, 31, 32, through the internet 50.

Each video program broadcasting system 10 includes a channel which sends the video program to the client computers 30, 31, 32, through the broadcasting network 40. The video program broadcasting system 10, in its embodiment, may be a cable TV company, which provides broadcasting service through their cable system.

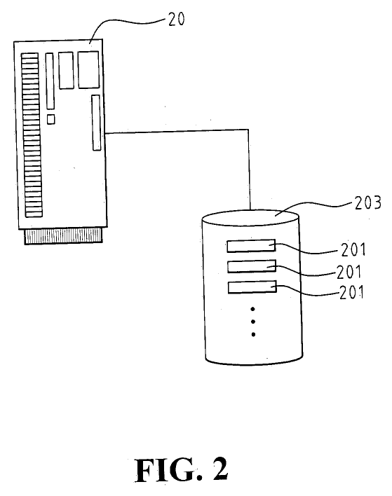

FIG. 2 shows a plurality of digital video programs 201 being stored on the video server 20. Each stored digital program 201 corresponds to a broadcasted video program 101. The video server 20 receives the user instruction 301 from the computer clients 30, 31, 32 through the internet 50. The user instruction 301 may be a record instruction 3011, which instructs the video server 20 to send the digital video program 201, as specified by the instruction 3011, through the internet 50 to the client computer 30, 31, 32.

The video server 20 also includes all the related information about the video programs on the video broadcasting system 10, such as program titles, program schedule, etc., so that the video server 20 knows the correspondence between the broadcasted programs and the stored digital videos 201.

As shown in FIG. 2, the video server 20 includes a database 203 to store the digitized videos 201 of the programs broadcasted on the system 10. The use of a database allows the present invention to include the related information of the requested video in the record instruction 3011. The related information is used by the database 203 of the video server 20 to index and access the corresponding digital video 201. In its embodiment, the related information may be the combination of a channel number and the broadcasting time, such as Oct. 20, 2002, 9 AM, on Channel 38. With this information, the database 203 can index and access the stored digital video 201 corresponding to the video program broadcasted at 9 AM, on Oct. 20, 2002, on Channel 38.

If the embodiment of the broadcasting system uses an analog signal transmission, the broadcasted video program would be in the form of analog signals. The technical details of the digitization of analog signals are beyond the scope of the present invention, and would not be included in the description. The present invention would employ the available digitizing techniques for converting the analog programs to digital videos 201.

The client computers 30, 31, 32 select the channel, and receives the broadcasted program of the broadcasting system 10 through the broadcasting network 40. The client computers 30, 31, 32, also send user instructions 301 through the internet 50 to the video server 20. For example, when the instruction 301 sent by the client computer 30 is a record instruction 3011, the client computer 30 is able to simultaneously receiving and recording the requested digital video 201 sent by the video server 20 through the internet 50, while receiving the program broadcasted through the broadcasting network 40. When multiple record instructions are issued, the present invention can process and execute the multiple record instructions simultaneously, while watching a broadcasted program.

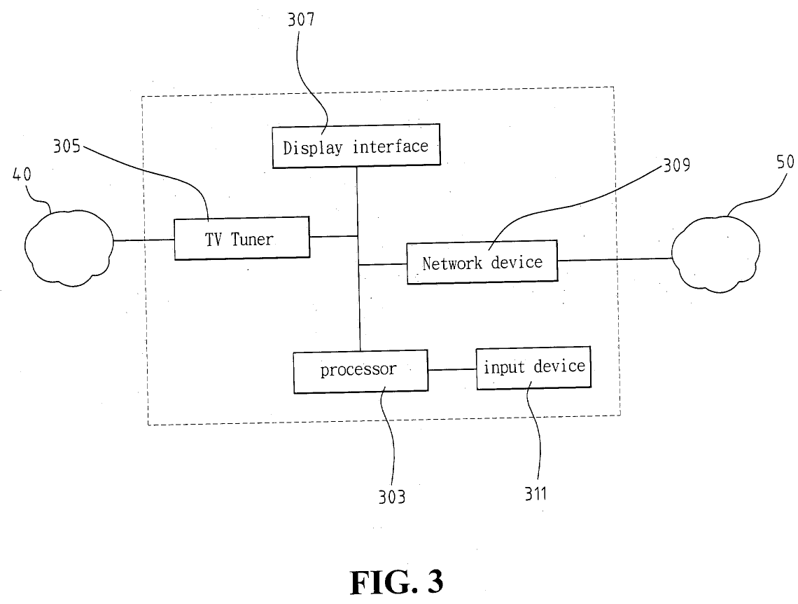

As shown in FIG. 3, the client computers 30, 31, 32 at least comprise of a TV tuner 305, for selecting channel and receiving programs through broadcasting network 40; a network device 309, for connecting to the internet 50; a display interface 307, for outputting the broadcasted program; and a processor 303, for processing a plurality of user instructions 301.

The present invention provides the user instructions 301 for various applications. They include the following: record instruction 3011, instant replay instruction 3013, rating calculation instruction 3015, preview instruction 3017, poll instruction 3019, alternative view instruction 3021, episode selection instruction 3023, pause instruction 3025, channel auto-sync instruction 3027, multi-channel viewing 3029, and message delivery instruction 3030.

To achieve the goal of the provision of a plurality of user instructions 301, the embodiment of client computers 30, 31, 32, may include an input device 311, such as a remote control. The users at the client computers 30, 31, 32 press the buttons on the input device 311, each corresponding to a user instruction 301. The processor 303, after processing the input signal, sends an internet packet containing the instruction 301, through the network device 309 and the internet 50 to the video server 20. Upon receiving and processing the internet packet, the video server 20 sends the digital video 201 or its related information, as specified in the instruction 301 contained in the packet, to the client computer 30, 31, 32.

On the other hand, in another embodiment of the present invention, the client computers 30,31, 32 may include a virtual input device, displayed in the region in the display interface 307. For example, a virtual remote control may be displayed for the users at the client computers 30, 31, 32 to click on using devices such as a computer mouse. After clicking on the buttons on the virtual remote control, each corresponding to a user instruction 301. The processor 303, after processing the input signal, sends an internet packet containing the instruction 301, through the network device 309 and the internet 50 to the video server 20. Upon receiving and processing the internet packet, the video server 20 sends the digital video 201 or its related information, as specified in the instruction 301 contained in the packet, to the client computer 30, 31, 32.

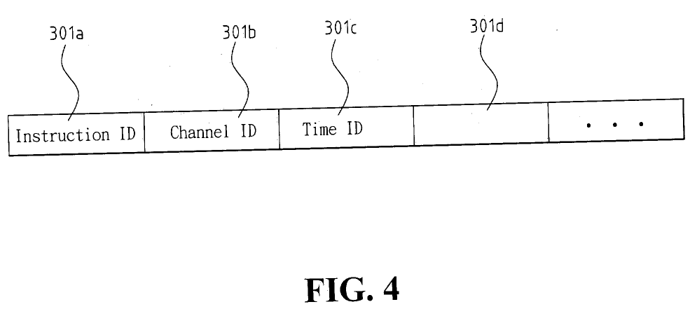

FIG. 4 shows the format of the data structure of the user instructions 301. The data field 301a is an instruction ID field, used for identifying the instruction type. For example, “01” in the field means a record instruction, and “02” in the field means an instant replay instruction. The data field 301b is a channel ID field, used for identifying the number of the channel. For example, “38” in the channel ID field indicates the channel 38. The data field 301c is a time ID field, used for indicating the time. For example, “2002/10/02/10:30:0” in the time ID field complies to the format of yy/mm/dd/hh:mm:ss. The data field 301d is a field for storing instruction related information. For example, in the poll instruction, the field 301d stores the answer returned by the user. The data fields 301a, 301b, 301c can uniquely identify an individual digital video 201, and the user's request. Combined with the program schedule stored on video server 20, the video server 20 knows exactly what video 201 is requested by the instruction 301 issued by the client computers 30, 31, 32.

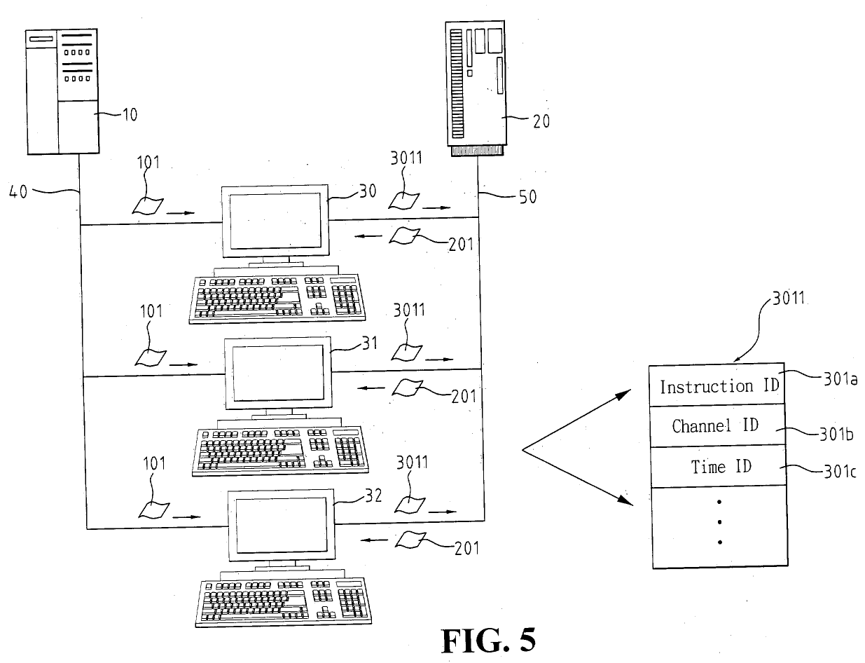

FIG. 5 shows a structure diagram of executing a record instruction. The client computers 30, 31, 32 issue the record instruction 3011. The processor 303 processes the issued instruction 3011, and sends an internet packet to the video server 20. The video server, upon receiving the internet packet, will send the requested digital video program 201 stored on it to the client computers 30, 31, 32. Hence, the viewers can watch a program while recording another program on a different channel.

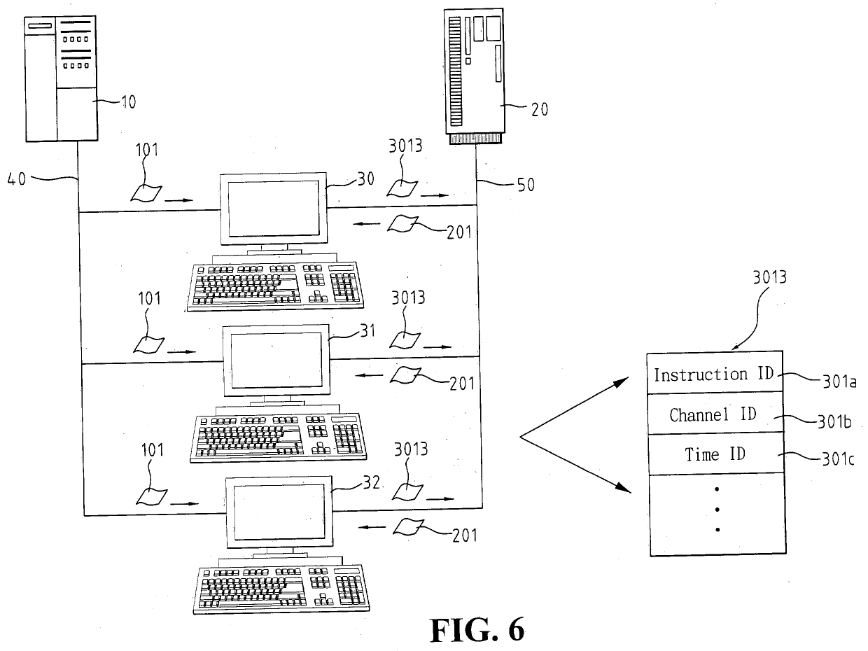

FIG. 6 shows a structure diagram of executing an instant replay instruction. The client computers 30, 31, 32 issue the record instruction 3013. The processor 303 processes the issued instruction 3013, and sends an internet packet to the video server 20. The video server, upon receiving the internet packet, will send the requested digital video program 201 for instant replay to the client computers 30, 31, 32. Hence, the viewers can immediately view the instant replay of the currently viewed program.

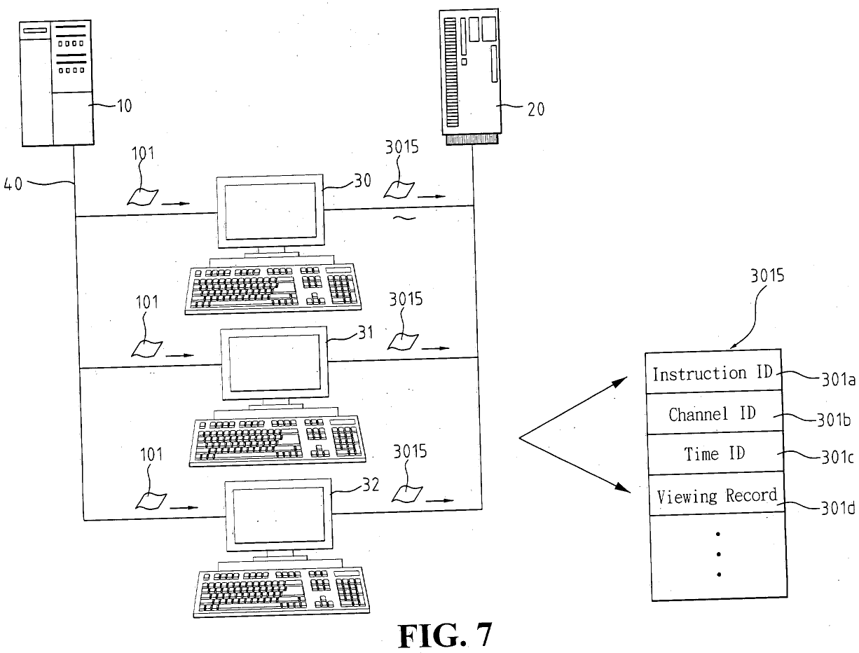

FIG. 7 shows a structure diagram of executing a rating calculation instruction. The client computers 30, 31, 32, while viewing a broadcasted program 101, issue the rating calculation instruction 3015, if the viewing lasts longer than a certainly pre-set period of time, for instance, 5 minutes. The processor 303 processes the issued instruction 3015, and sends an internet packet to the video server 20. The video server, upon receiving the internet packet, will update the viewing information of the video program 201, as specified by the instruction 3015. Hence, the system can keep record of the viewing rating of each individual program 201.

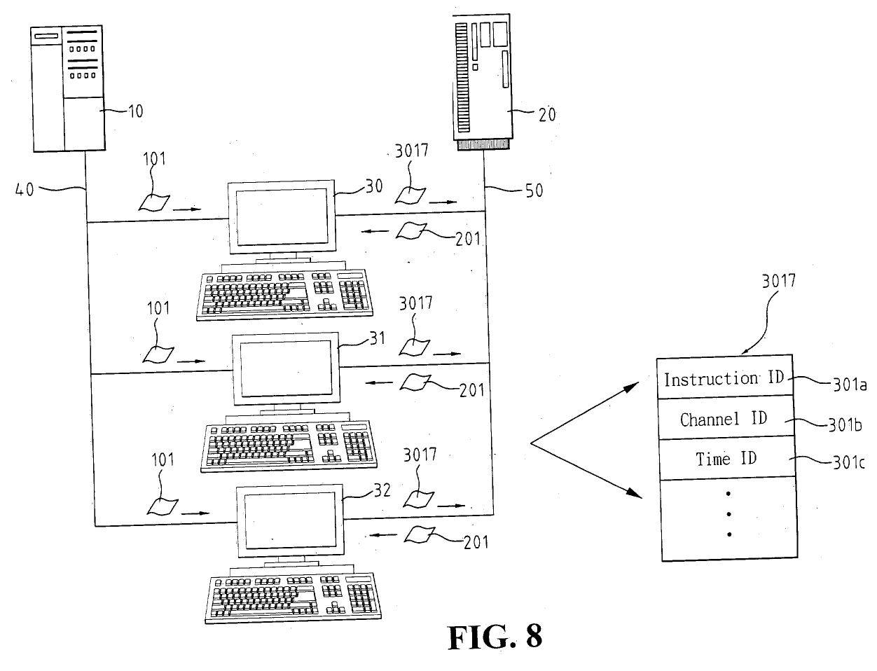

FIG. 8 shows a structure diagram of executing a preview instruction. The client computers 30, 31, 32, while viewing a trailer of a broadcasted video 101, issue the preview instruction 3017. The processor 303 processes the issued instruction 3017, and sends an internet packet to the video server 20. The video server, upon receiving the internet packet, will send the requested digital video program 201 stored on it to the client computers 30, 31, 32. Hence, the viewers can view the previewed program immediately without delay.

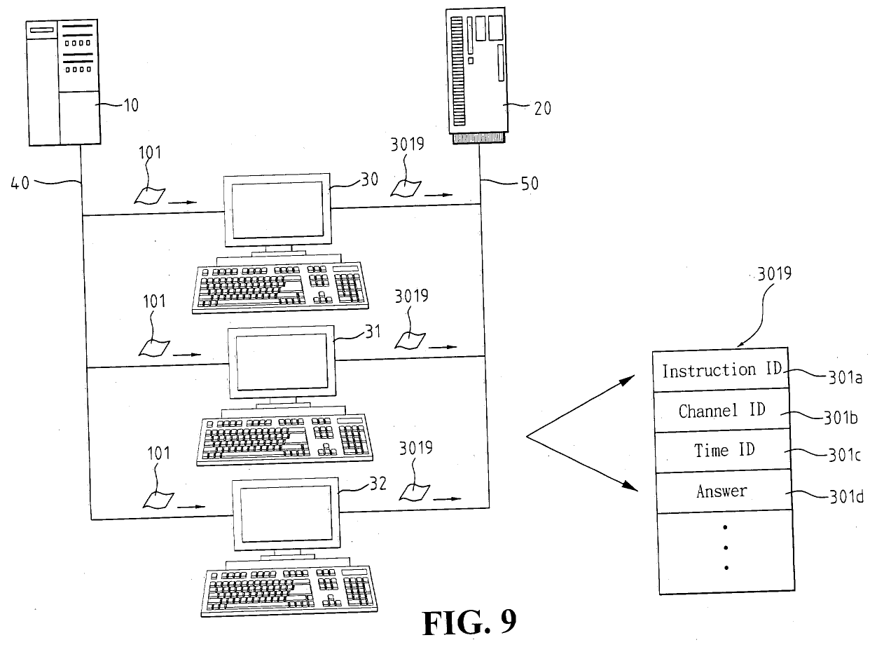

FIG. 9 shows a structure diagram of executing a poll instruction. The client computers 30, 31, 32, while viewing a program 101 with polling function, for example, multiple choice, select the answer through a remote control or a virtual remote control. The selected answer forms an poll instruction 3019, the processor 303 processes the issued instruction 3019, and sends an internet packet to the video server 20. The video server, upon receiving the internet packet, will update the polling information of the digital video program 201, according to the answer specified by the instruction 3019. Hence, the system can keep track of the polling results of the stored video program 201.

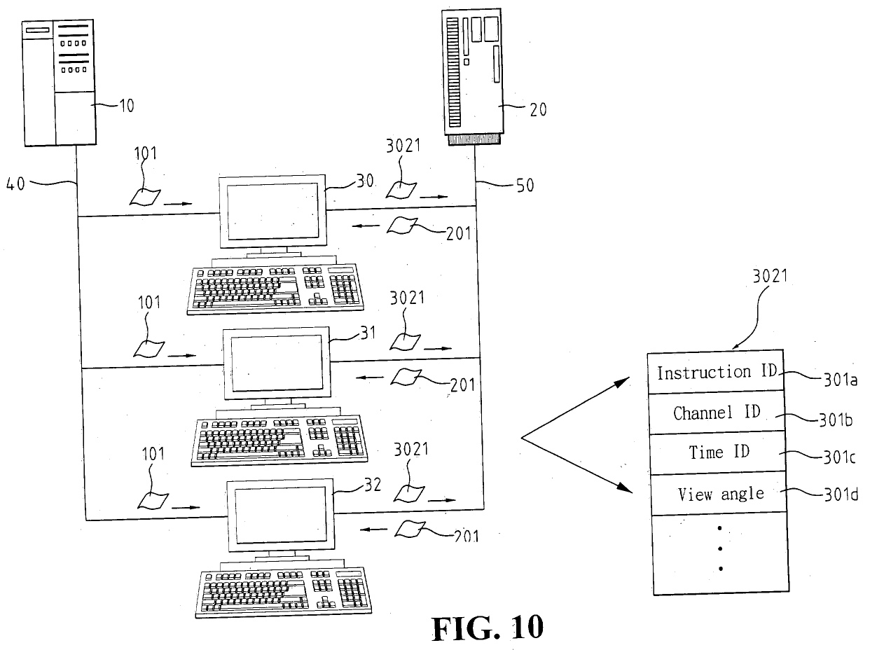

FIG. 10 shows a structure diagram of executing an alternative view instruction. The client computers 30, 31, 32, while viewing the broadcasted program 101, issue the alternative view instruction 3021. The processor 303 processes the issued instruction 3021, and sends an internet packet to the video server 20. The video server, upon receiving the internet packet, will send the requested digital video program 201 of a different viewing angle to the client computers 30, 31, 32. Hence, the viewers can watch a program with a different viewing angle.

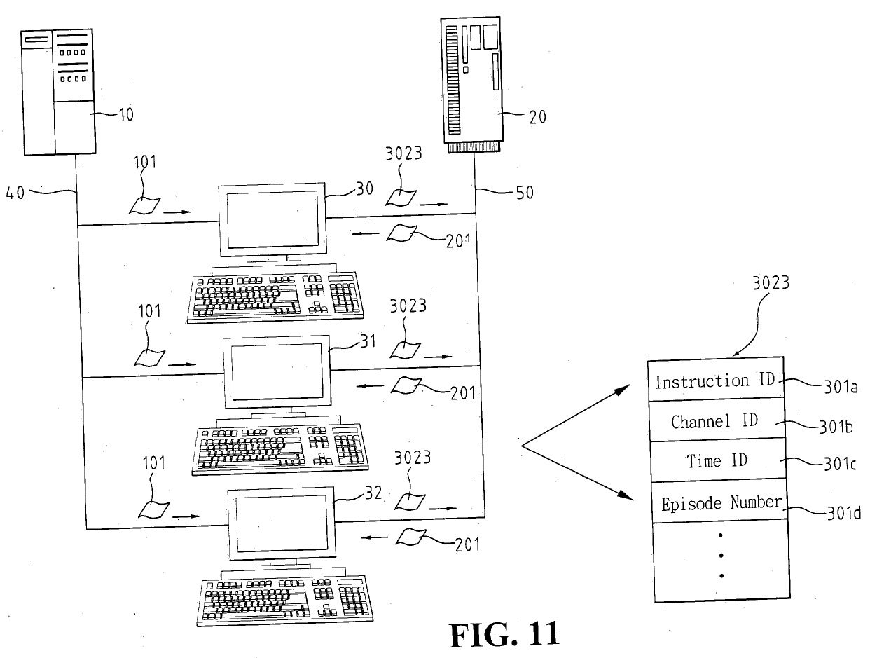

FIG. 11 shows a structure diagram of executing an episode selection instruction. The client computers 30, 31, 32, while viewing a broadcasted program 101, issue the episode selection instruction 3023. The processor 303 processes the issued instruction 3023, and sends an internet packet to the video server 20. The video server, upon receiving the internet packet, will send the requested digital video program 201 stored on it to the client computers 30, 31, 32. Hence, the viewers can select any episode for viewing.

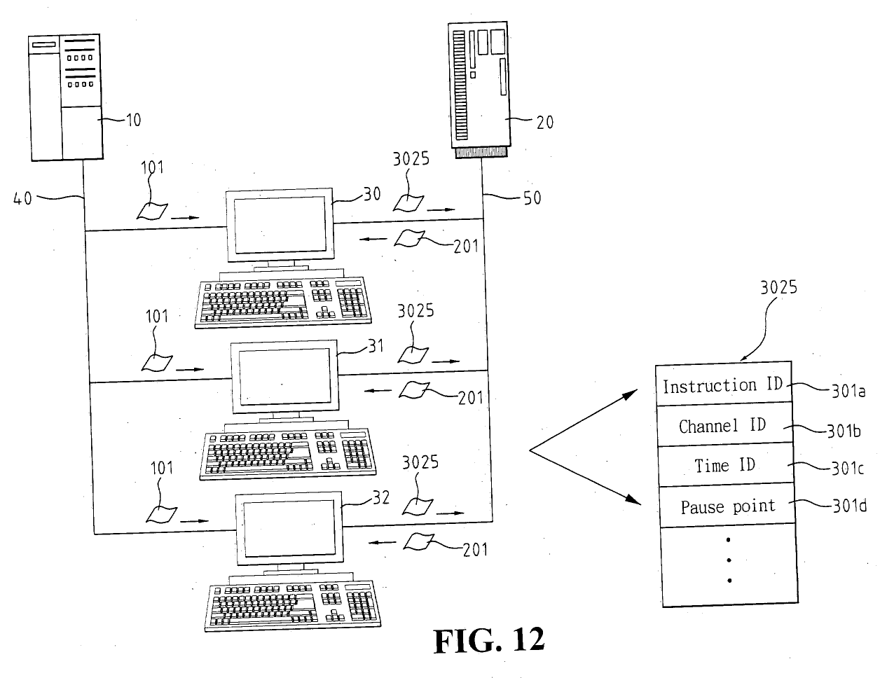

FIG. 12 shows a structure diagram of executing a pause instruction. The client computers 30, 31, 32, while viewing a broadcasted program 101, issue the pause instruction 3025. The processor 303 processes the issued instruction 3025, freezes the image on the screen, and sends an internet packet to the video server 20. The video server, upon receiving the internet packet, will send the requested digital video program 201, resuming at the previously paused point, to the client computers 30, 31, 32. Hence, the viewers can stop and resume the viewing any time.

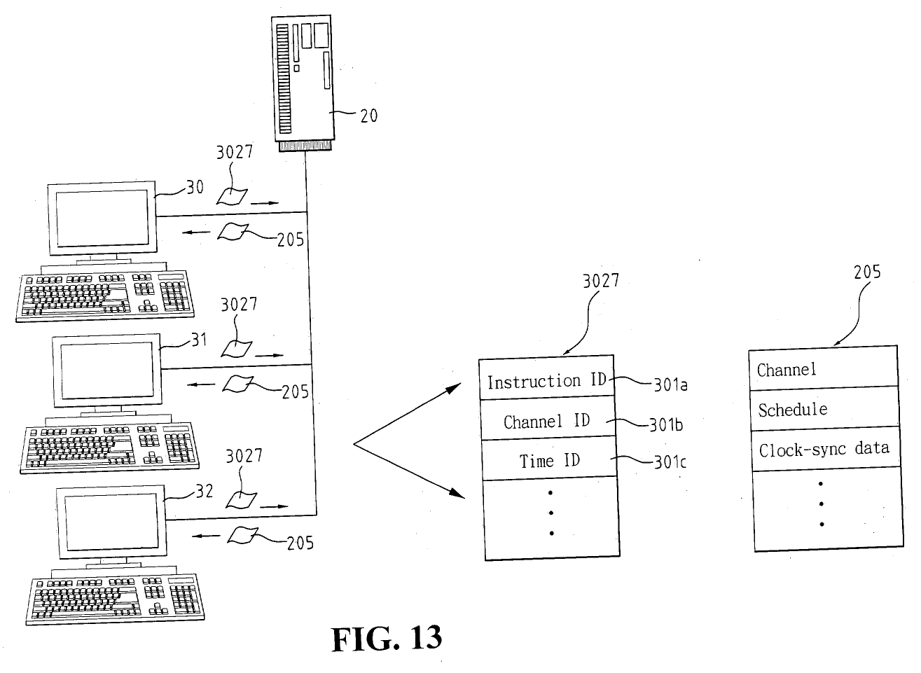

FIG. 13 shows a structure diagram of executing a channel auto-sync instruction. The client computers 30, 31, 32 issue the auto-sync instruction 3027 to obtain the program schedule of a specified channel, and to synchronize with clock of that channel. The processor 303 processes the issued instruction 3027, and sends an internet packet to the video server 20. The video server, upon receiving the internet packet, will send the requested digital video program 201, together with an internet packet 205 containing clock information for synchronization, to the client computers 30, 31, 32. Hence, the viewers can synchronize with the clock on a specific channel. The channel auto-sync instruction 3027 of the present invention has the following features:

1. Provides the client computers 30, 31, 32 the capability to synchronize with the broadcasting system 10 as to avoid missing the program due to the time discrepancy;

2. Uses the channel names to replace the channel number as to avoid the confusion of the different channel numbers in different region; and

3. After executing the channel auto-sync instruction, the viewers will obtain the most up-to-date program schedule.

With the aforementioned channel auto-sync instruction, the present invention allows advanced personal instructions. According to the program schedule, the viewers can select and set their own viewing schedule, for example, on Monday time A to watch channel C1, time B to watch channel C5, and so on. By setting the selected viewing schedule, and save it in the client computers 30, 31, 32, the viewers can use the aforementioned remote control or virtual remote control to activate the personal instruction, and the client computers 30, 31, 32 can automatically switch to the channel set by the schedule.

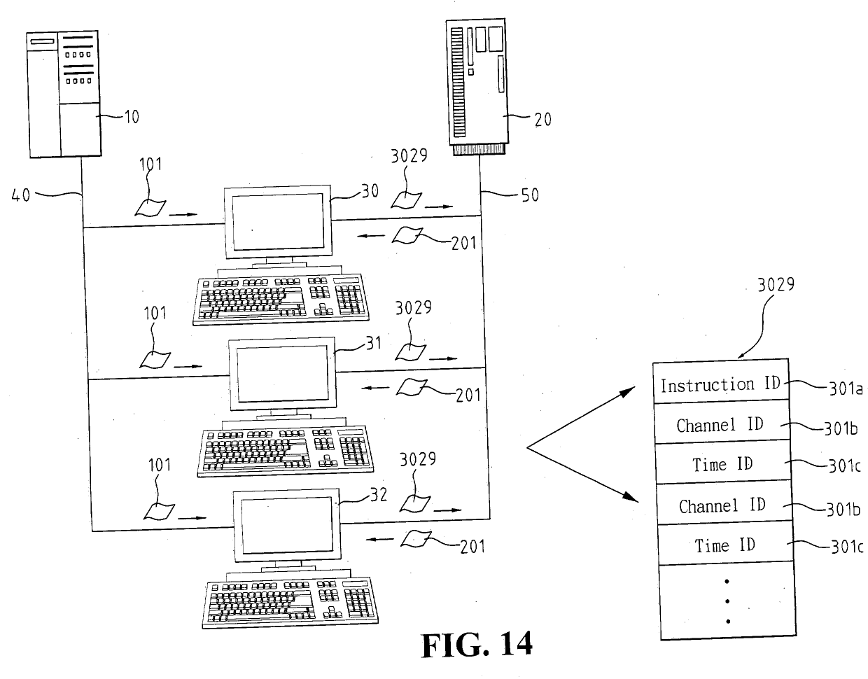

FIG. 14 shows a structure diagram of executing a multi-channel view instruction. The client computers 30, 31, 32, while viewing broadcasted program 101, issue a multi-channel instruction 3029. The processor 303 processes the instruction, and sends an internet packet to video server 20. The video server 20, upon receiving the internet packet containing the instruction 3029, will send the requested video programs 201 one by one to the client computers. As shown in FIG. 14, the multi-channel view instruction 3029 contains a list of field-pairs. A pair consists of a channel ID 301b and a time ID 301c, and specifies a digital video program 201. The client computers 30, 31, 32 use one or more smaller viewing windows to display the video programs 201. Hence, the viewers are able to watch multiple programs in smaller viewing windows while watching the broadcasted program 101.

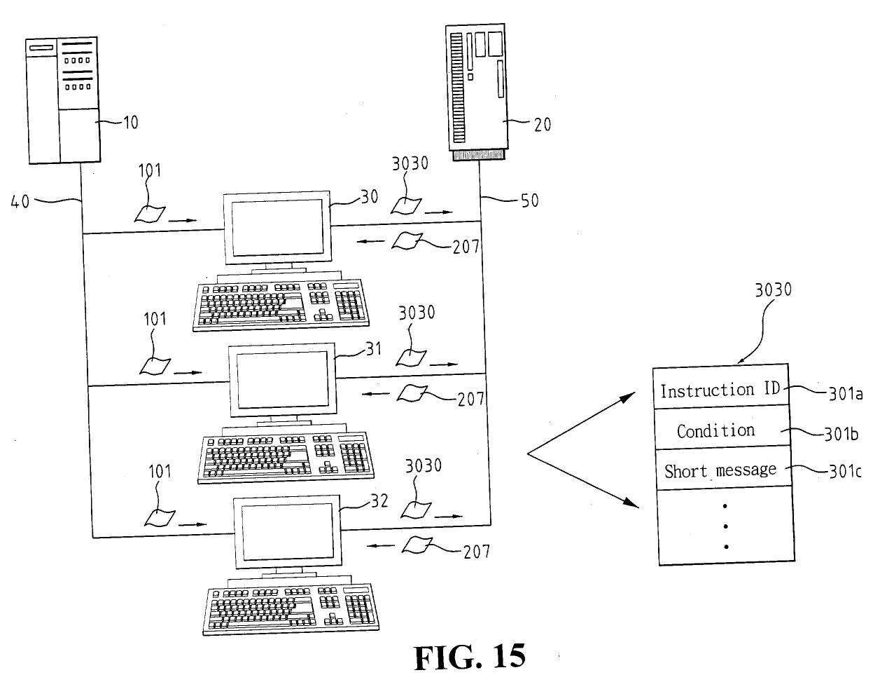

FIG. 15 shows a structure diagram of executing a message delivery instruction. The client computers 30, 31, 32, while viewing broadcasted program 101, issue a message delivery instruction 3030. The processor 303 processes the instruction, and sends an internet packet to video server 20. The packet includes the conditions on which the specified client computers are allowed to receive the contents of the short message. The video server 20, upon receiving the internet packet containing the instruction 3030, will send the short message packet 207 one by one to the client computers that meet said conditions. As shown in FIG. 15, the message delivery instruction 3030 contains a condition field 301b to specify which client computers are allowed to receive the contents of the short message, such as age, gender, or interests. With the mechanism of condition specification, the system is able to categorize different client groups, allows communication within the group. The short message field 301c contains the contents of the short message. The system allows a client to send and receive short messages in a separate window, while watching a broadcasted program 101.

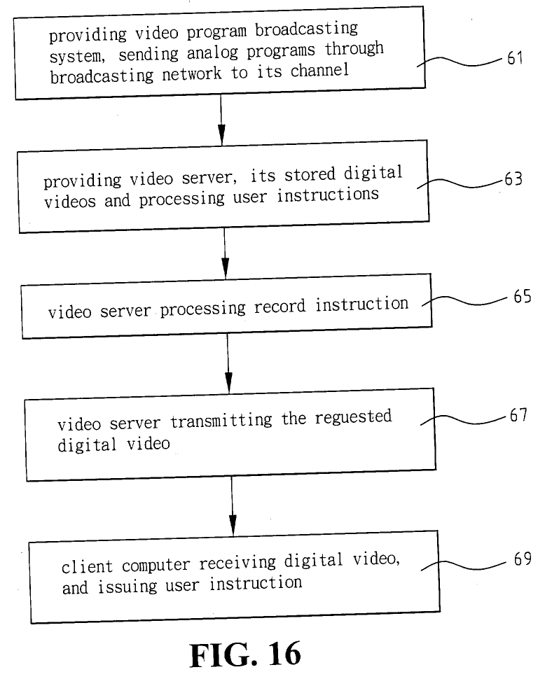

FIG. 16 shows the flowchart for the method of the present invention. The present invention is a remote control video recording and playing method, comprising the following steps: Step (61) provides at least a video program broadcasting system 10, wherein a channel sending video programs 101 through the broadcasting network 40 to the computers 30, 31, 32 at the client's end; Step (63) provides at least a video server 20, wherein a plurality of digital video programs 201, each corresponding to a broadcasted video program 101, being stored; Step (65), the video server 20 is able to receive, through internet 50, a plurality of user instructions 301 sent from client computers 30, 31, 32, wherein at least one of said instructions being record instruction 3011; Step (67) said video server 20 sends the corresponding digital video programs 201, specified in step (65), to the computer at the client end 30, 31, 32, through the internet 50; Step (69) a client computer 30, 31, 32 is used for selecting channels, and sending instructions 301 to the video server 20; wherein said client computer 30, 31, 32 being able to simultaneously receive the selected video programs 101 broadcasted through the network 40, and record a plurality of digital video programs 201, each requested with a separate instruction 301, sent by the said video server 20 through the internet 50.

With present invention, the system is able to provide the following features to the viewers:

1. viewing one channel, while recording a plurality of other channels simultaneously;

2. stopping and resuming the viewing of a program;

3. selecting any episode in a series;

4. requesting the previewing of a program, without waiting;

5. participating in polling survey and rating calculation;

6. browsing the program schedule;

7. personalizing the program schedule;

8. sending message to viewers; and

9. selecting an alternative viewing angle of a program.

The present invention has disclosed the hardware realization of client computer. The similar hardware structure, such as, intelligent appliances, personal computers, notebook computers, multi-function game machines that provide similar or equivalent functionality should be all considered within the definition of the client computers.

The broadcasting network disclosed in the present invention for connecting the video program broadcasting system and the client computers is just to meet the requirement of the complete disclosure, rather than to restrict the present invention to its only use. Cables, network cables, other analog signal cables, other digital signal cables, and other media able to transmit a video program or provide similar or equivalent functionality should be all considered within the definition of the broadcasting network.

While we have shown and described the embodiment in accordance with the present invention, it should be clear to those skilled in the art that further embodiments may be made without departing from the scope of the present invention.

What is claimed is:

1. A remote control recording and playing video system, comprising:
(1). at least a video program broadcasting system, wherein said video program broadcasting system including a channel sending video programs through the broadcasting network to the computers at the client's end;
(2). at least a video server, wherein said video server storing a plurality of digital video programs, each corresponding to a broadcasted video program; said video server being able to receive the user instructions, and to send the stored digital videos to the computer at the client end, both through the internet; and
(3). at least a client computer, wherein said client computer being used for selecting channels, and sending instructions to the video server; said client computer being able to receive the video programs broadcasted through the network, and record a plurality of digital video programs in the video server, each requested with a separate instruction, sent by said video server through the internet simultaneously.

2. A system claimed as in claim 1, wherein said a plurality of user instructions include: an instant replay instruction, a rating calculation instruction, a preview instruction, a polling instruction, an alternative view instruction, an episode selection instruction, a pause instruction, a channel auto-sync instruction, a personalization instruction, a multi-channel view instruction, and a message delivery instruction.

3. A system claimed as in claim 1, wherein said video server includes at least a database for storing said digitized video programs.

4. A system claimed as in claim 1, wherein said client computer further comprising:
a TV tuner, for receiving a broadcasted video program;
a network device, for connecting to the internet;
a display interface, for displaying the received broadcasted program; and
a processor, for processing said plurality of user instructions.

5. A remote control video recording and playing method, comprising:
(a). providing at least a video program broadcasting system, wherein a channel sending video programs through the broadcasting network to the computers at the client's end;
(b). providing at least a video server, wherein a plurality of digital video programs, each corresponding to a broadcasted video program, being stored;
(c). said video server being able to receive a plurality of user instructions sent from client computers, wherein at least one of said instructions being recording instruction;
(d). said video server sending the corresponding digital video programs, specified in step (c), to the computer at the client end, through the internet;
(e). a client computer being used for selecting channels, and sending instructions to the video server; wherein said client computer being able to simultaneously receive the selected video programs broadcasted through the network, and record a plurality of digital video programs, each requested with a separate instruction, sent by the said video server through the internet.

6. A method claimed as in claim 5, wherein said a plurality of user instructions include: an instant replay instruction, a rating calculation instruction, a preview instruction, a polling instruction, an alternative view instruction, an episode selection instruction, a pause instruction, a channel auto-sync instruction, a personalization instruction, a multi-channel view instruction, and a message delivery instruction.

7. A method claimed as in claim 5, wherein said video server includes at least a database for storing said digitized video programs.

8. A method claimed as in claim 5, wherein said client computer further comprising:
a TV tuner, for receiving a broadcasted video program;
a network device, for connecting to the internet;
a display interface, for displaying the received broadcasted program; and
a processor, for processing said plurality of user instructions.
